(19) United States
(12) Patent Application Publication
(10) Pub. No.: US 2019/0011595 A1
(43) Pub. Date: Jan. 10, 2019

(54) MULTICOMPONENT INDUCTION DATA PROCESSING FOR FRACTURED FORMATIONS

(71) Applicant: Halliburton Energy Services, Inc., Houston, TX (US)

(72) Inventors: Junsheng Hou, Kingwood, TX (US); Chao-Fu Wang, Singapore (SG); Glenn A. Wilson, Houston, TX (US)

(21) Appl. No.: 16/067,184

(22) PCT Filed: Mar. 15, 2016
(86) PCT No.: PCT/US2016/022467

§ 371 Date: Jun. 29, 2018

(51) Int. Cl. G01V 3/38; G01V 3/28; E21B 44/00; E21B 47/00

(52) U.S. Cl. CPC G01V 3/38; E21B 47/00; E21B 44/00; G01V 3/28

(57) ABSTRACT

Evaluation of formations and fracture characterization based on multicomponent induction (MCI) log data includes automated calculation of biaxial anisotropy (BA) parameters by performing iterative inversion operations based on the MCI log data. Biaxially anisotropic effect corrected (BAC) logs are BA anisotropic effect corrected using the inverted BA parameters. The inverted BA parameters can also be used for identification and quantification of fractures in formations.

### BACKGROUND

Modern operations for the exploration and production of oil and gas rely on access to a variety of information regarding subsurface geological parameters and conditions. Such information typically includes characteristics of Earth formations traversed by a borehole, as well as data relating to the size and mud of the borehole itself. The collection of information relating to subsurface properties and conditions, which is commonly referred to as “logging,” can be performed by several methods, including wireline logging and logging while drilling (LWD).

In wireline logging, a sonde is lowered into the borehole after some or all of the well has been drilled. The sonde hangs at the end of a wireline cable that provides mechanical support to the sonde and also provides an electrical connection between the sonde and electrical equipment located at the surface. In accordance with existing logging techniques, various parameters of the Earth's formations are measured and correlated with the position of the sonde in the borehole as the sonde is pulled uphole. In LWD, a drilling assembly includes sensing instruments that measure various parameters as the formation is penetrated, thereby enabling measurement of the formation during the drilling operation. Among the available wireline and LWD tools are a variety of resistivity logging tools including devices configured for making multi-component induction (MCI) measurements.

### BRIEF DESCRIPTION OF THE DRAWINGS

FIG. 1 is a schematic view of a system for capturing subsurface measurement data in a logging while drilling operation, in accordance with one or more example embodiments.

FIG. 2 is a schematic view of a system for capturing subsurface measurement data in a wireline logging operation, in accordance with one or more example embodiments.

FIG. 3 is a schematic diagram depicting an example configuration of a multi-array, tri-axial induction tool, in accordance with one or more example embodiments.

FIG. 4 is a diagram of a radially one-dimensional borehole-formation model for borehole correction in transversely isotropic formations, in accordance with one or more example embodiments.

FIG. 5 is a diagram of a radially one-dimensional borehole-formation model for borehole correction in biaxially anisotropic formations, in accordance with one or more example embodiments.

FIG. 6 is a flow diagram of an example method for MCI data processing, in accordance with one or more example embodiments.

FIG. 7 is a set of plots illustrating the sensitivity of MCI data to formation dip, in accordance with one or more example embodiments.

FIG. 8 is a set of plots illustrating the sensitivity of MCI data to x-directed resistivity Rx, in accordance with one or more example embodiments.

FIG. 9 is a set of plots illustrating the sensitivity of MCI data to Rzx, in accordance with one or more example embodiments.

FIG. 10 is a set of plots illustrating the sensitivity of MCI data to Rxy, in accordance with one or more example embodiments.

FIG. 11 is a flow diagram of an example method comprising multi-model inversion processing based on the R1D-TI model, OD TI/BA model, and V1D model, in accordance with one or more example embodiments.

FIG. 12 is a flow diagram of an example method comprising multi-model inversion processing based on the R1D-BA model, OD TI/BA model, and V1D model, in accordance with one or more example embodiments.

FIG. 13 is a schematic block diagram of a system for real-time evaluation of formation biaxial anisotropy using MCI measurements, in accordance with one or more example embodiments.

FIG. 14 is a diagrammatic representation of a machine in the example form of a computer system within which a set of instructions for causing the machine to perform any one or more of the methodologies discussed herein may be executed.

### DETAILED DESCRIPTION

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

### Introduction

Multi-component induction (MCI) logging can be used for determining formation resistivity (or conductivity, which is the inverse of the resistivity), dip, and azimuth strike. Some processing and interpretation schemes are based on simplified transversely isotropic (TI) formation models. A TI model can account for resistivity differences between, on the one hand, orthogonal axes lying in a formation or bedding plane (sometimes referred to as the horizontal or transverse plane), and, on the other hand, an axis perpendicular to the formation or bedding plane (sometimes referred to as the vertical axis). The TI model thus can account for anisotropy between the “vertical” axis and the “horizontal” plane, but assumes isotropy between different axes in the “horizontal” or transverse plane. For this reason, the TI model is also referred to being TI anisotropic. Unless the text or context clearly indicates otherwise, “horizontal” or “transverse” means a direction or plane substantially coinciding with a bedding plane of the relevant formation, and “vertical” means a direction of plane substantially orthogonal to the bedding plane of the relevant formation. Data processing and interpretation based on assuming TI anisotropy in the formation can be used for determining horizontal and vertical resistivities, dip, and azimuth/strike in the TI formation.

However, many geological formations contain different types of natural and/or non-natural fractures. This includes several different geological factors (e.g., fractures, cross-bedding, and varied depositional conditions in the bedding plane), the most common being fractures that vertically cut across the formations. If the formation contains fractures or faults that cut across the formation bedding, formation resistivity (or conductivity) will no longer be TI anisotropic. Fractured formations very often manifest as being biaxially anisotropic (BA) in the macroscopic petrophysical properties. A biaxially anisotropic model additionally accounts for anisotropy between orthogonal axes in the transverse plane, and is therefore also referred to as accounting for triaxial anisotropy. Note that, unless otherwise specified, “biaxial anisotropy” and its derivations refer to transverse biaxial anisotropy. Consistent with this terminology, a TI model does not account for biaxial anisotropy, even though it accounts for anisotropy between two axes (e.g., between the horizontal plane and the vertical axis)

Failure to take BA anisotropy into account can lead to incorrect or inaccurate results based on inversion of formation resistivity and dip, consequently resulting in misinterpretation of MCI measurements for the ensuing petrophysical applications. For example, instances where high formation dips (e.g., up to 90-degrees) are identified from inversion based on a TI model, especially where there is a significant resistivity/conductivity contrast between fractures and their background formations, can result in mischaracterization of formation and/or fracture properties. Moreover, fractures often play a critical role for fluid flow in formations arid oil/gas production, especially for unconventional reservoirs.

For this reason, accurate characterization of formation BA anisotropy can be used to identify and quantify fractures, as disclosed with reference to the example embodiments that follow. Accurate estimation of fracture characteristics can promote successful development of a tight, heavily fractured reservoir, as the fractures play a significant role for both reservoir fluid flow and well productivity.

One or more example embodiments described below provide a fast and practical method and system for multi-model inversion and correction of biaxially anisotropic effects in fractured formations. This disclosure describes methods for determining formation anisotropy, dip, arid azimuth using multicomponent induction measurements in biaxially anisotropic formations. MCI logging data, such as formation dip and its azimuth are first obtained using conventional MCI data processing, including the obtaining of formation horizontal resistivity and vertical resistivity. Afterwards, multi-model inversion processing based on multiple forward models are used that enable recovery of more accurate formation parameters (e.g., anisotropic parameters and dip), and provision of parameters for use in automated fracture estimation(including fracture identification and quantification).

### Example Measurement Environments

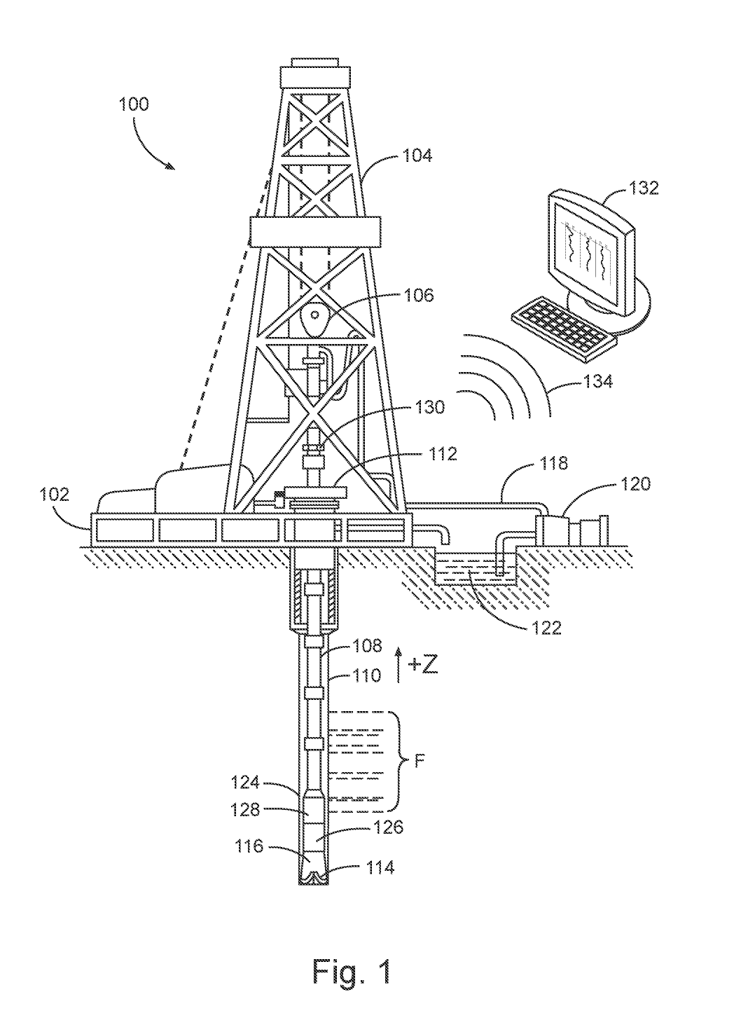

The disclosed systems and methods are best understood in the context of the larger systems in which they operate. Accordingly, FIG. 1 illustrates an example logging while drilling (LWD) or measuring while drilling (MWD) system 100, in accordance with one or more example embodiments. A drilling rig or platform 102 supports a derrick 104 or other supporting structure, such as including or coupled to a hoist 106. The hoist 106 is used for raising or lowering equipment or other apparatus such as drill string 108. The drill string 108 accesses a borehole 110, also known as a wellbore, such as through a wellhead 112. The borehole 110 may be drilled in any direction, for example, vertical, inclined, horizontal, and combinations thereof. The lower end of the drill string 108 includes various apparatus, such as a drill head 114, to provide the borehole 110. A downhole motor assembly 116 rotates the drill head 114. As the drill head 114 rotates, it extends the borehole 110 that passes through various subsurface formations F. The downhole motor assembly 116 may include a rotary steerable system (RSS) that enables the drilling crew to steer the borehole 110 along a desired path.

Drilling fluid or “mud” circulates in the annular region around the drill head 114 or elsewhere, such as provided to the borehole 110 through a supply pipe 118, circulated by a pump 120, and returning to the surface to be captured in a retention pit 122 or sump. The drilling fluid transports cuttings from the borehole into the retention pit 122 and aids in maintaining the borehole integrity.

The drill head 114 and downhole motor assembly 116 form a portion of a bottom hole assembly (BHA) 124 that includes one or more drill collars (thick-walled steel pipe) to provide weight and rigidity to aid the drilling process. Various subs or tool assemblies may also be located along the drill string 108 and/or in the BHA 124. As the BHA 124 passes through various regions of the formation F, information may be obtained. For example, the BHA 124 may include a resistivity logging tool 126 that collects measurements relating to various formation properties as well as the tool orientation and/or other drilling conditions. As the drill head 114 extends the borehole 110 through the subsurface formations F, the resistivity logging tool 126 collects multicomponent induction (MCI) measurements as well as measurements of parameters such as position, orientation, weight-on-bit, borehole size, drilling fluid resistivity, and various other drilling conditions.

Tool orientation may be specified in terms of a tool face angle (rotational orientation or azimuth), an inclination angle (the slope), and compass direction, each of which can be derived from measurements by magnetometers, inclinometers, and/or accelerometers, though other sensor types such as gyroscopes may alternatively be used. In one specific embodiment, the tool includes a 3-axis fluxgate magnetometer and a 3-axis accelerometer. As is known in the art, the combination of those two sensor systems enables the measurement of the rotational tool face angle, borehole inclination angle (aka “slope”), and compass direction (aka “azimuth”). Such orientation measurements can be combined with gyroscopic or inertial measurements to accurately track tool position. In some embodiments, the tool face angle and borehole inclination angles are calculated from the accelerometer sensor output. The magnetometer sensor outputs are used to calculate the borehole azimuth. With the tool face angle, the borehole inclination, and the borehole azimuth information, various resistivity logging tools disclosed herein can be used to steer the bit to the desired bed.

A telemetry sub 128 is included in the bottom hole assembly (BHA) 124 to provide a communications link with the surface. The telemetry sub 128 includes wireless telemetry or logging capabilities, or both, such as to transmit or later provide information relating to multicomponent induction data to operators on the surface or for later access in evaluation of formation F properties. Mud pulse telemetry is one common telemetry technique for transferring tool measurements to a surface interface 130 and to receive commands from the surface interface 130, but other telemetry techniques can also be used. For example, the surface interface 130 includes one or more of wireless telemetry, processor circuitry, or memory facilities, such as to support log-while-drilling (LWD) or measurement-while-drilling (MWD) operations.

A surface processor, shown in FIG. 1 in the form of a computer 132, communicates with surface interface 130 via a wired or wireless network communications link 134, and provides a graphical user interface (GUI) or other form of interface that enables a user to provide commands and to receive and optionally interact with a visual representation of the acquired measurements. The surface processor can take alternative forms, including a desktop computer, a laptop computer, an embedded processor, a cloud computer, a central processing center accessible via the Internet, and any combination of the foregoing. In many examples, the surface processor will include one or more processors in combination with additional hardware as needed (volatile and/or non-volatile memory; communication ports; I/O device(s) and ports; etc.) to provide the formation dip and azimuth determinations as described herein. An example surface processor can serve to control the functions of the drilling system 100 and to receive and process downhole measurements transmitted from the telemetry sub 128 to control drilling parameters. In such examples, one or more a non-volatile, machine-readable storage devices (i.e., a memory device (such as DRAM, FLASH, SRAM, or any other form of storage device; which in all cases shall be considered a non-transitory storage medium), a hard drive, or other mechanical, electronic, magnetic, or optical storage mechanism, etc.) will contain instructions suitable to cause the processor to describe the desired functionality, such as the various examples discussed herein). The surface processor operates in accordance with software (which may be stored on non-volatile, machine-readable storage devices) and user input via an input device to process and decode the received signals. The resulting telemetry data may be further analyzed and processed by the surface processor to generate a display of useful information on a computer monitor or some other form of a display device. Of course, these functions may be implemented by separate processing units, as desired, and additional functions may be performed by such one or more processing units in response to similarly stored instructions.

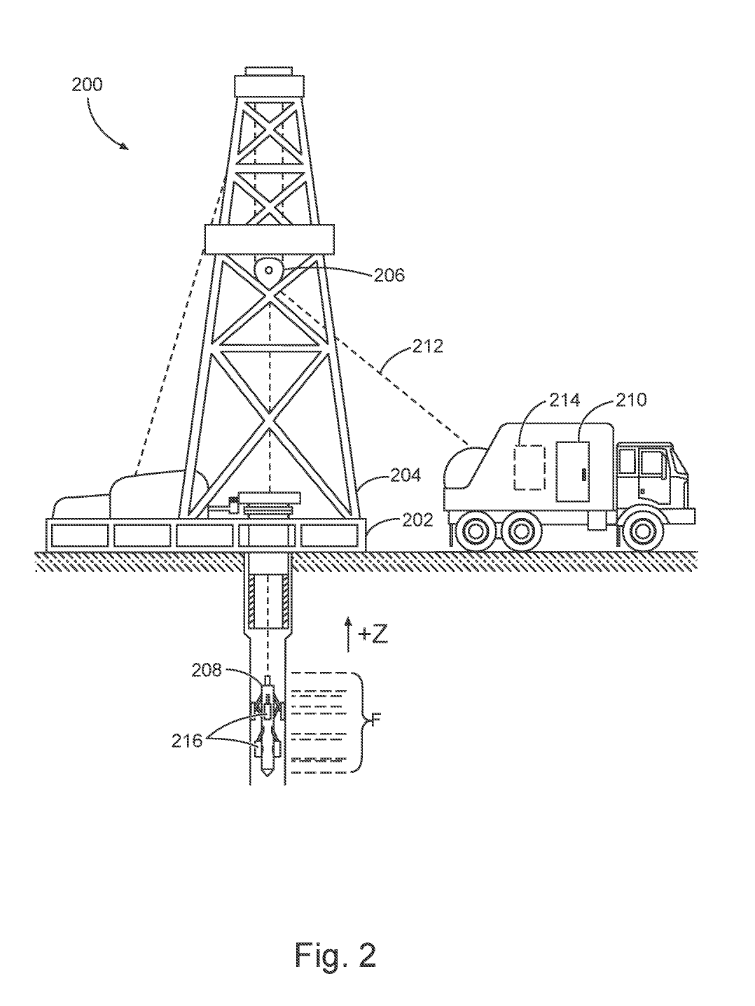

At various times during the drilling process, the drill string 108 may be removed from the borehole, allowing wireline logging operations to be conducted in a wireline logging system 200 as shown in FIG. 2, in accordance with one or more example embodiments. A platform 202, such as coupled to a derrick 204, includes a hoist 206 that is used to raise or lower equipment such as a wireline logging tool 208, such as a wireline sonde, into or out of a borehole. The wireline logging tool 208 may have pads and/or centralizing springs to maintain the tool near the axis of the borehole as the tool traverses the borehole. In this wireline example, a logging facility 210 (e.g., logging truck) suspends the wireline logging tool 208 on a wireline cable 212 providing a communicative coupling between the wireline logging tool 208 and the logging facility 210.

Measurements from the formation F may be obtained, such as using a resistivity logging tool included as at least a portion of the wireline logging tool 208. The wireline cable 212 includes conductors for transporting power to the tool and telemetry from the tool to the surface, where the logging facility 210 includes a processor 214 (e.g., a computer or other storage or control circuitry) that acquires and stores measurement data from the wireline logging tool 208.

For purposes of illustration, the examples of FIGS. 1 and 2 show a vertically-oriented borehole configuration. However, the tools and methods described herein may also be used in other borehole configurations, such as a borehole including a horizontal penetration direction, or an oblique borehole configuration, for example. The examples of FIGS. 1 and 2 also generally illustrate land-based examples. Alternatively, the apparatus and techniques described herein may be used in offshore environments as well, such as for subsea operations. In particular, offshore or subsea operations may include use of wireline or LWD/MWD apparatus and techniques including aspects of the examples herein.

### MCI Tensor Measurements

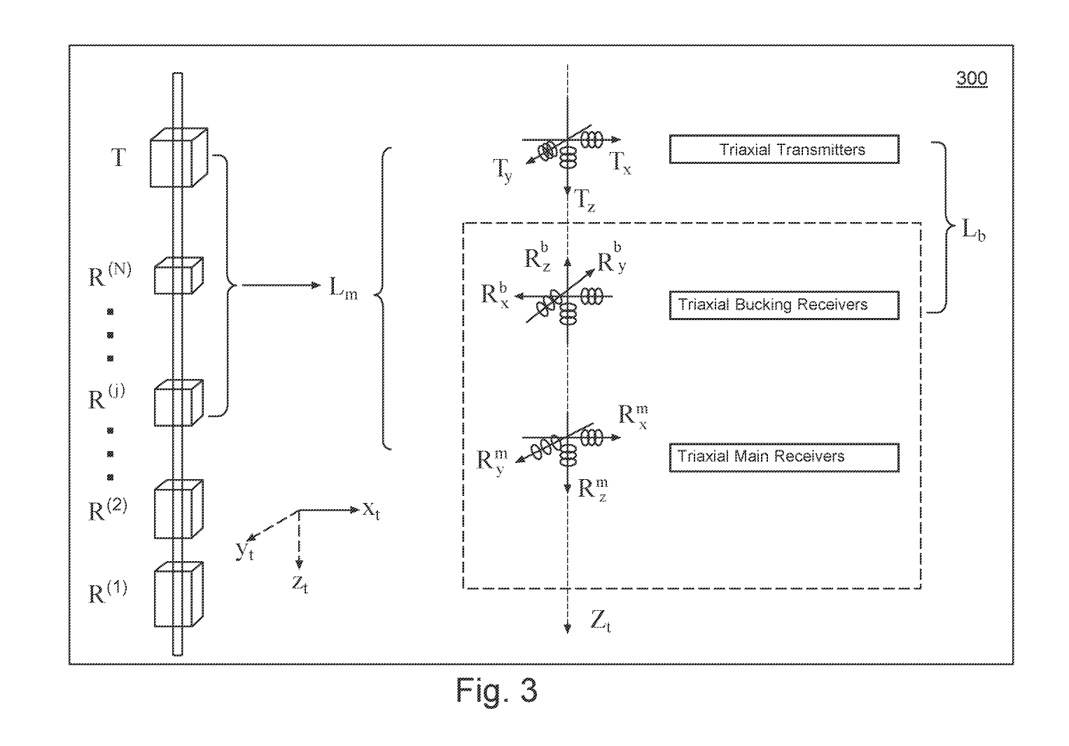

FIG. 3 is a schematic diagram showing an example configuration of a resistivity logging tool 300, in accordance with one or more example embodiments. The resistivity logging tool 300 is a multi-array, tri-axial induction tool having antennas for acquiring multi-component induction logging measurements. The resistivity logging tool 300 includes multiple tri-axial sub-arrays (e.g., TR⁽¹⁾, TR⁽²⁾, . . . , and TR^{(N)}), with each sub-array comprising three mutually orthogonal and collocated antennas. A triad of transmitters (e.g., Tₓ, T_{y}, and T_{z}) represent magnetic dipole antennas oriented parallel to the tool's x, y, and z axes, respectively. A triad of main receivers (e.g., , , , and) represent magnetic dipole antennas oriented along those axes, as do a triad of bucking receivers (e.g., , , , and). In some embodiments, the signal measurements of the bucking receiver triad can be subtracted from the main receiver triad to eliminate the direct signal from the transmitter and increase sensitivity to formation properties.

Each tri-axial sub-array includes the transmitter triad (Tₓ, T_{y}, and T_{z}), and a separate main receiver triad ( , , , and) and bucking receiver triad ( , , , and) for each receiver (e.g., R⁽¹⁾, R⁽²⁾, and R^{(N)}). The main receiver triad is spaced at a distance Lₘ from the transmitter triad, and the bucking receiver triad is spaced at a distance L_{b} from the transmitter triad. In the antenna configuration of resistivity logging tool 300, if each transmitter of a tri-axial sub-array is fired in turn, and signal measurements are made at each receiver in response to each firing, nine different voltage measurements are produced at every log depth in a measurement coordinate system (e.g., denoted as xₜ, yₜ, zₜ in FIG. 3).

Voltages measured at the receivers are converted into apparent conductivities. The apparent conductivities can be expressed as a 3 by 3 tensor (also known as, a matrix) for a multi-array, tri-axial tool operated at multiple frequencies, which may be represented in the following manner:

$$\begin{matrix}\overline{\overline{{σ}_{a}^{( i , j )}}} = ( \begin{matrix}{σ}_{xx}^{( i , j )} & {σ}_{xy}^{( i , j )} & {σ}_{xz}^{( i , j )} \\ {σ}_{yx}^{( i , j )} & {σ}_{yy}^{( i , j )} & {σ}_{yz}^{( i , j )} \\ {σ}_{zx}^{( i , j )} & {σ}_{zy}^{( i , j )} & {σ}_{zz}^{( i , j )}\end{matrix} ) = {( {σ}_{IJ}^{( i , j )} )}_{( 3 \times 3 )} \\ or & ( 1 ) \\ \overline{\overline{{σ}_{a}^{( i , j )}}} = ( \begin{matrix}{XX}^{( i , j )} & {XY}^{( i , j )} & {XZ}^{( i , j )} \\ {YX}^{( i , j )} & {YY}^{( i , j )} & {YZ}^{( i , j )} \\ {ZX}^{( i , j )} & {ZY}^{( i , j )} & {ZZ}^{( i , j )}\end{matrix} ) = {( {IJ}^{( i , j )} )}_{( 3 \times 3 )} & ( 2 )\end{matrix}$$

In the above conductivity tensor, I, J=x (or X), y (or Y), z (or Z), i=1, 2, . . . , N; j=1, 2, . . . , M. σ̅ₐ̅^̅{̅(̅i̅,̅ j̅)̅}̅ is referred to as the MCI apparent conductivity tensor (R- or X-signal) in the tool coordinate system. σ_{IJ}^{(i, j)} are the measured-conductivity couples of σ̅ₐ̅^̅{̅(̅i̅,̅ j̅)̅}̅, wherein subscript I indicates the transmitter direction and subscript J indicates the receiver direction. When I, J=x/X, σ_{IJ}^{(i, j)} is σₓₓ^{(i, j)} (or XX^{(i, j)}), when I, J=y/Y, σ_{IJ}^{(i, j)} is σ_{yy}^{(i, j)} (or YY^{(i, j)}), and when I, J=z/Z, σ_{IJ}^{(i, j)} is σ_{zz}^{(i, j)} (or ZZ^{(i, j)}), which are the traditional multi-array induction measurements, wherein N represents the total number of the tri-axial sub-arrays and M represents the total number of operated frequencies. Therefore, 2*9*M*N R-signal and X-signal data should be present for each log point.

### Data Processing Based on Radially One-Dimensional and Zero-Dimensional Models

Radially one-dimensional (R1D) and zero-dimensional (0D) MCI processing algorithms are used for the real-time recovering of formation horizontal resistivity (Rₕ), vertical resistivity (Rᵥ), dip, and azimuth, based either on a radially one-dimensional (R1D) borehole-formation model or a zero-dimensional (0D) formation model. The R1D model is based on a borehole with a circular cross section, the borehole being surrounded by an infinitely-thick and homogenous formation. The borehole may be vertical or deviated, with the MCI logging tool traversing the borehole at either a centralized or a decentralized position within the borehole.

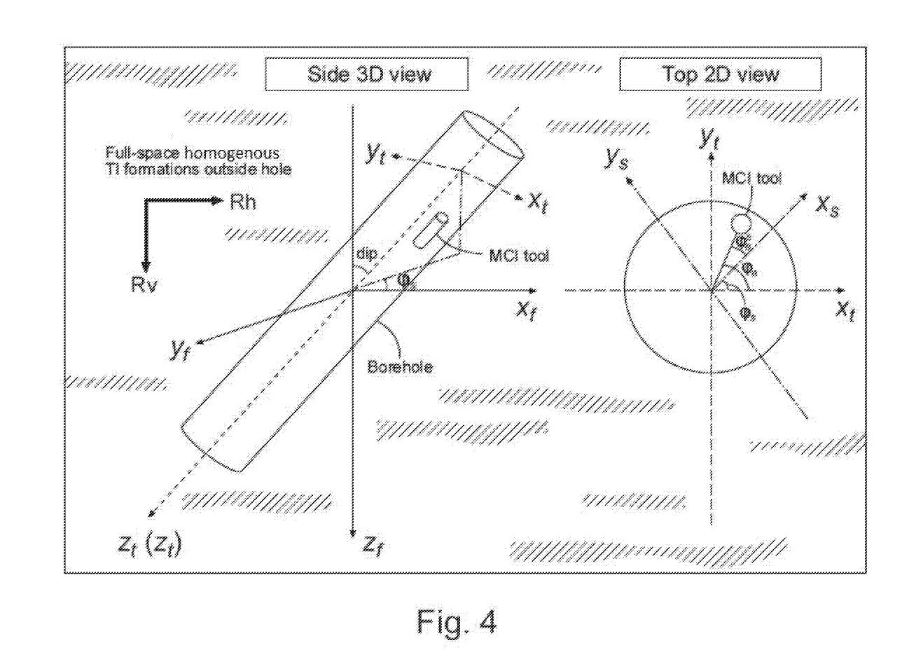

FIG. 4 is a diagram of an example radially one-dimensional (R1D) borehole-formation model for borehole correction in transversely isotropic formations, in accordance with one or more example embodiments. The homogenous, full-space formation outside of the borehole may be either isotropic or anisotropic (e.g., transversely anisotropic). Formation resistivity or conductivity can be isotropic or transversely isotropic (TI). The coordinates (xₜ, yₜ, and zₜ) represent the MCI tool system, coordinates (x_{f}, y_{f}, and z_{f}) represent the formation system, and coordinates (xₛ, yₛ, and zₛ) represent the strike system. For example, in a dipping bed, the x-axis may be oriented in the direction of deepest ascent (e.g., uphill or downhill). When the formation coordinate system is aligned in this manner, it may be termed “strike-aligned.” The MCI tool can be either centralized or decentralized in the borehole and surrounded by the full-space formation. If no borehole exists, the R1D model reduces to a zero-dimensional (0D) formation model (not shown). For the purposes of this disclosure, this is referred to as the R1D-TI model.

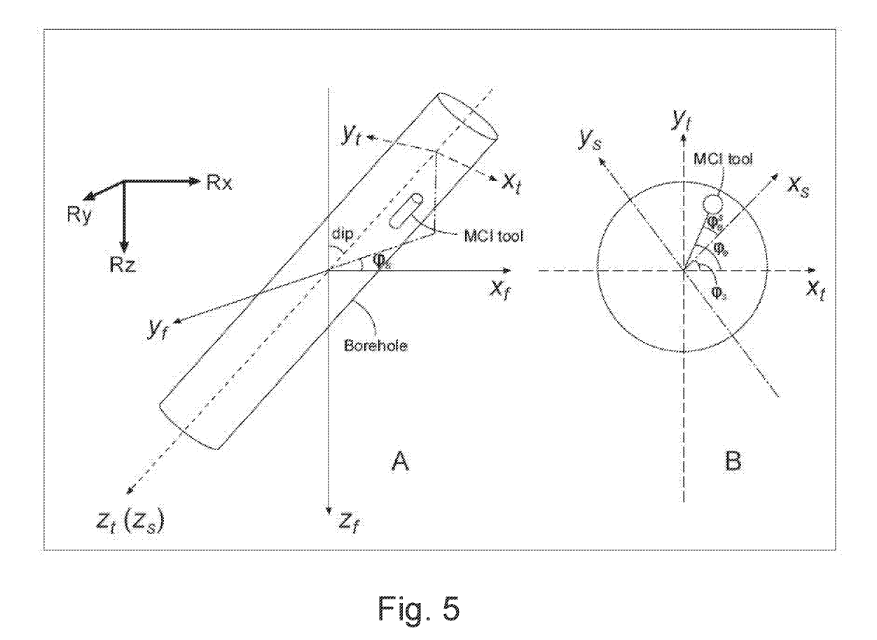

FIG. 5 is a diagram of an example radially one-dimensional (R1D) borehole-formation model for borehole correction in biaxially anisotropic formations, in accordance with one or more example embodiments. The homogenous, full-space formation outside of the borehole is biaxially anisotropic. The coordinates (xₜ, yₜ, and zₜ) represent the MCI tool system, coordinates (x_{f}, y_{f}, and z_{f}) represent the formation system, and coordinates (xₛ, yₛ, and zₛ) represent the strike system. For example, in a dipping bed, the x-axis may be oriented in the direction of deepest ascent (e.g., uphill or downhill). When the formation coordinate system is aligned in this manner, it may be termed “strike-aligned.” The MCI tool can be either centralized or decentralized in the borehole and surrounded by the full-space formation. For the purposes of this disclosure, this is referred to as the R1D-BA model.

In the above-described R1D models, if the model only consists of a homogeneous unbounded formation, then it is also referred to as a zero-D (0D) model. For a BA formation, which is hereinafter referred to as the 0D-BA model, five parameters (Rx, Ry, Rz, dip, and azimuth strike) can be used to describe the model. Due to the mathematical complexity in the numerical simulation for this 0D model, the MCI responses may be pre-calculated and saved into a data library and used as the forward engine in the 0D inversion. As the MCI responses at non-zero strikes can be obtained by rotating the responses to the zero strike, only responses spanned in the 4-dimensional space of the variables Rx, Ry, Rz and dip need be pre-calculated, thus making the data library much smaller. Moreover, if the hole is surrounded by a layered formation with invasion, it may be modeled as a three-dimensional (3D) model, while a vertical one-dimensional (V1D) model can be employed for a layered formation without hole and invasion.

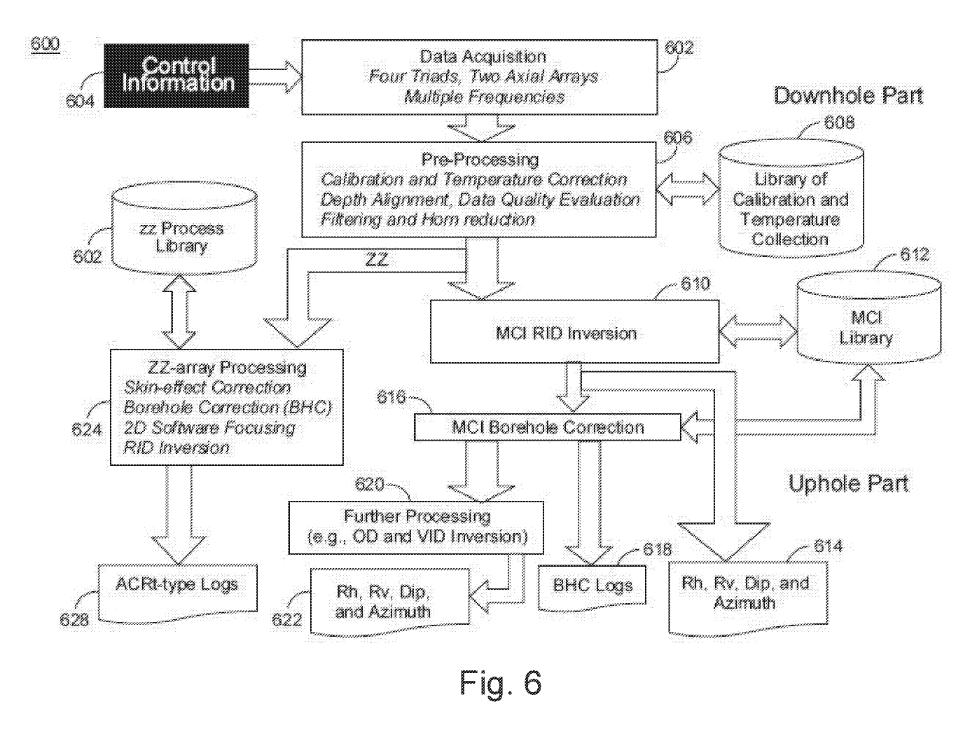

FIG. 6 shows an example flow diagram of a processing method 600 for determination of formation properties using MCI measurements, in accordance with one or more example embodiments. The method 600 provides for real-time determination of formation horizontal and vertical resistivities (Rx, Ry, and Rz), dip, and strike/azimuth.

At operation 602, MCI measurement data is captured by a tri-axial MCI tool in a borehole extending through a subsurface geological formation using, for example, process control information 604. The MCI measurement data may be multi-frequency data, and may be taken at multiple spacings, or be the data at multiple frequencies and spacings. In some embodiments, the MCI measurement data can be single-frequency measurements for the respective arrays of the tool. At operation 606, calibration, temperature correction and other pre-processing are applied to the MCI measurement data based on the library of calibration and temperature correction 608. The pre-processing of operation 604 does not include skin-effect correction.

Operation 610 comprises MCI R1D inversion comprising an iterative operation using MCI library 612 to generate inverted formation and hole parameters 614 (e.g., formation Rh, Rv, dip, strike/azimuth, and tool position in a hole). Due to the use of the MCI library 612 as the inversion's forward engine, data processing can be performed in real time. The R1D inversion is based on a fast and rigorous multistep inversion algorithm and a fast forward modeling engine which can consist of a pre-calculated MCI-response library. The values are thus calculated for the inverted TI parameters for the formation. In operation 616, at least some of the inverted TI parameters are used to correct the MCI measurement data for borehole effects to generate BHC logs 618. In some embodiments, further processing (e.g., 0D and V1D inversions) may be performed at operation 620 to generate inverted formation parameters 622. 0D inversion may also provide the formation Rₕ, Rᵥ, dip, azimuth and can be used for evaluating the BHC results from operation 616. Both the R1D and 0D inversions are able to provide fast and accurate information regarding the formation Rₕ, Rᵥ, dip, and azimuth. But if the formation anisotropic ratio (Rᵥₕ=Rᵥ/Rₕ) is close to the unity, then the recovered dip and azimuth are not accurate, and if the formation relative dip angle is close to zero degrees, then only the calculated dip azimuth is not accurate. At operation 624, ZZ-array processing is performed using data from ZZ process library 626. ZZ-array processing can include skin effect correction (e.g., correction of frequency effects on ZZ-component measurements), borehole effect correction, 2D software focusing for reducing shoulder bed effects and enhancing log vertical resolution, and R1D inversion to invert the formation resistivity and invasion depth, resulting in conventional induction logs (e.g., ACRt-type logs 628).

Thus, method 600 determines formation anisotropy and dip based on a TI model to obtain formation horizontal and vertical resistivities (e.g., Rh and Rv, respectively), dip, and azimuth by using a variety of R1D inversion, 0D inversion, and V1D inversions. However, if fractures or faults cut across formations perpendicular to the bedding direction, the formations are no longer TI anisotropic and the accuracy of method 600 deteriorates.

In contrast to the example method 600 of FIG. 6, other examples may reorder the operations, omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

### MCI Sensitivity to Dip and Tri-Axial Resistivities

Formation parameters (Rₕ, Rᵥ, dip, and azimuth) may be extracted from measurements in the MCI data by the R1D and 0D inversion processing. It is known that MCI data measurements are sensitive to dip, horizontal and vertical resistivities in TI formations. Further, MCI data is also sensitive to formation dip, and tri-axial resistivities (Rx, Ry, and Rz) in BA formations. Numerical examples will now be presented to show MCI sensitivity to formation dip and different tri-axial resistivity values by using a 0D-BA formation model.

In these examples, the azimuth/strike of the x-axis in the formation's principal axis coordinate system is set to zero degree (for non-zero azimuth, MCI responses can be gained by the rotation of the responses at zero azimuth). In all these cases, due to the zero azimuth, only 5 components (3 direct component: XX, YY, and ZZ, and two cross components: XZ and ZX) are non-zero and we have XZ=ZX. Therefore, only four components XX, YY, ZZ, and XZ (or ZX) need be shown in the numerical simulated results. An example MCI tool includes four tri-axial subarrays (A1, A2, A3, and A4, here they are ordered based on their space length) operated at an example frequency of 36 kHz.

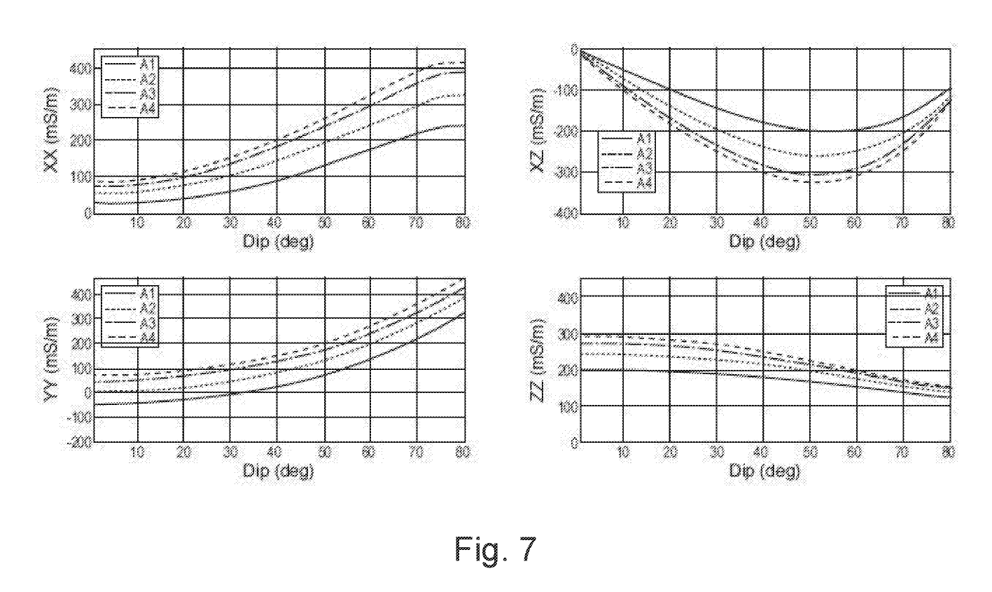

FIG. 7 illustrates plots of MCI simulated results of four tri-axial arrays at 36 kHz plotted as a function of formation dip. The MCI responses are calculated for a full-space biaxially anisotropic formation with fixed Rx=2 ohm-m Rzx=5, and Rzy=2. In these plots, the x-axis represents the formation dip and the y-axis represents a simulated MCI component.

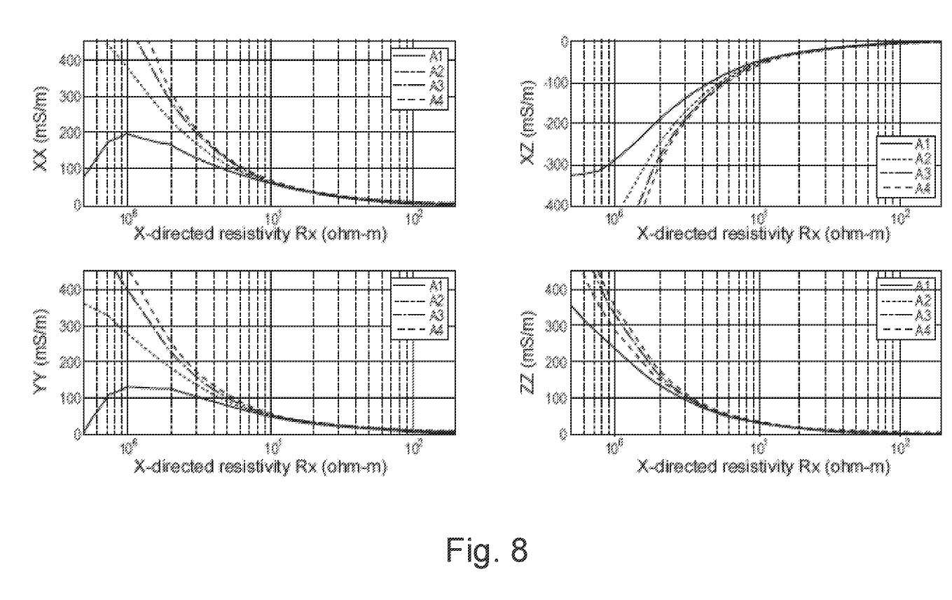

FIG. 8 illustrates plots of MCI simulated results of four tri-axial arrays at 36 kHz plotted as a function of x-directed resistivity (Rx). The MCI responses are calculated for a full-space biaxially anisotropic formation with fixed Rzx=5, Rzy=2, and the relative dip of the BA formation set to 60 degrees. In these plots, the x-axis represents Rx and the y-axis represents a simulated MCI component.

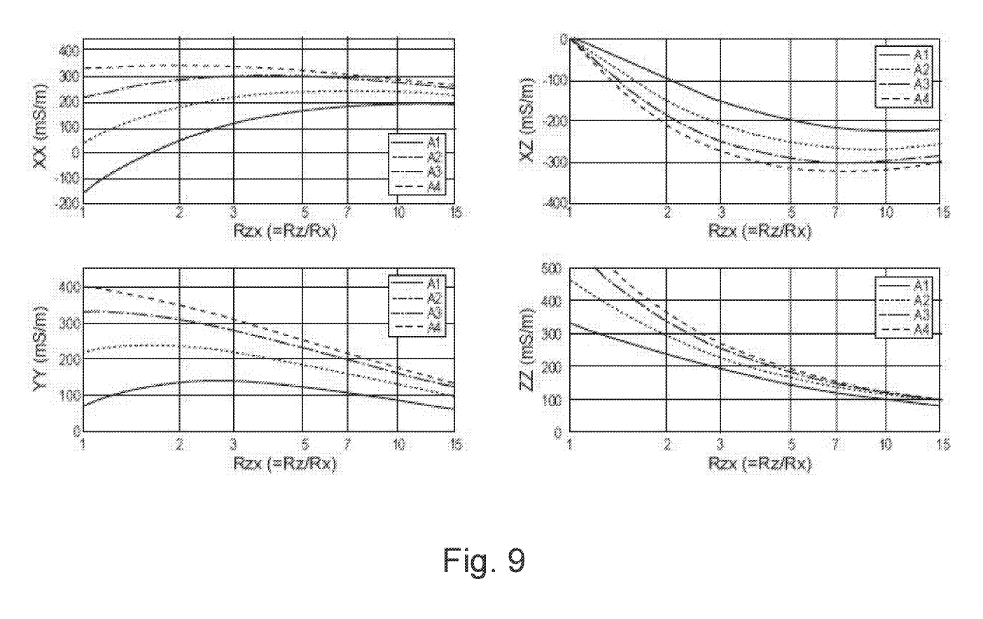

FIG. 9 illustrates plots of MCI simulated results of four tri-axial arrays at 36 kHz plotted as a function of the resistivity ratio Rzx (Rz/Rx). The MCI responses are calculated for a full-space biaxially anisotropic formation with fixed Rx=2 ohm-m, Rzy=2, and the relative dip of the BA formation set to 60 degrees. In these plots, the x-axis represents the resistivity ratio Rzx between z-directed and x-directed resistivities, and the y-axis represents a simulated MCI component.

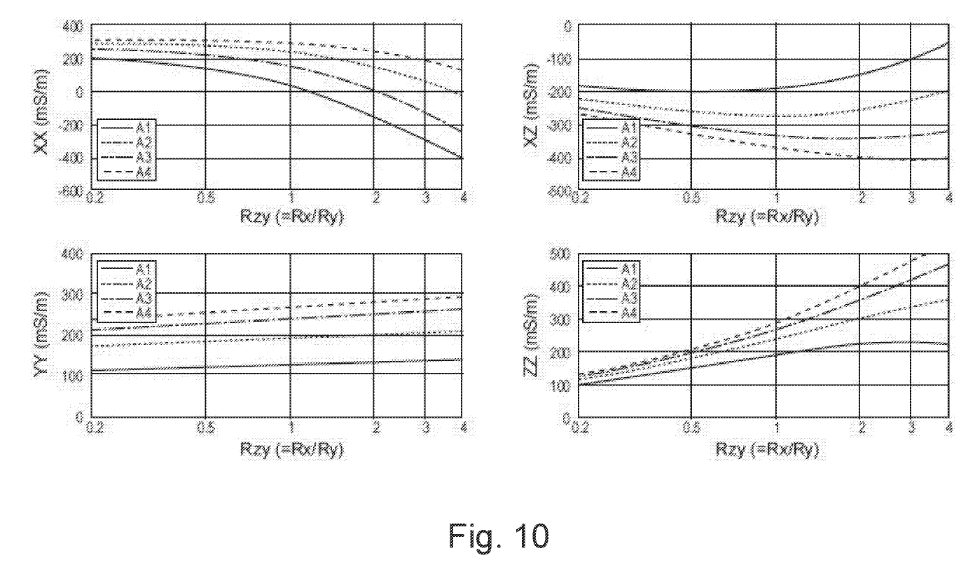

FIG. 10 illustrates plots of MCI simulated results of four tri-axial arrays at 36 kHz plotted as a function of the resistivity ratio Rxy (Rx/Ry). The MCI responses are calculated for a full-space biaxially anisotropic formation with fixed Rx=2 ohm-m, Rzx=5, and the relative dip of the BA formation set to 60 degrees. In these plots, the x-axis represents the horizontal resistivity ratio Rxy and the y-axis represents a simulated MCI component.

It can be observed that all four components (e.g., XX, XZ, YY, and ZZ) generally display good sensitivity to formation dip and tri-axial resistivities in biaxially anisotropic formations. It should be noted that the sensitivities vary for different frequencies, subarrays, and components. This insight suggests that MCI data can be used for inversion of BA formation parameters, and that the different sensitivities among different components, such as XX and YY, may be used to indicate the formation BA anisotropy resulting from fractures. Additionally, the response differences can be used for indicating fracture presence.

### Multi-Model Inversion Processing

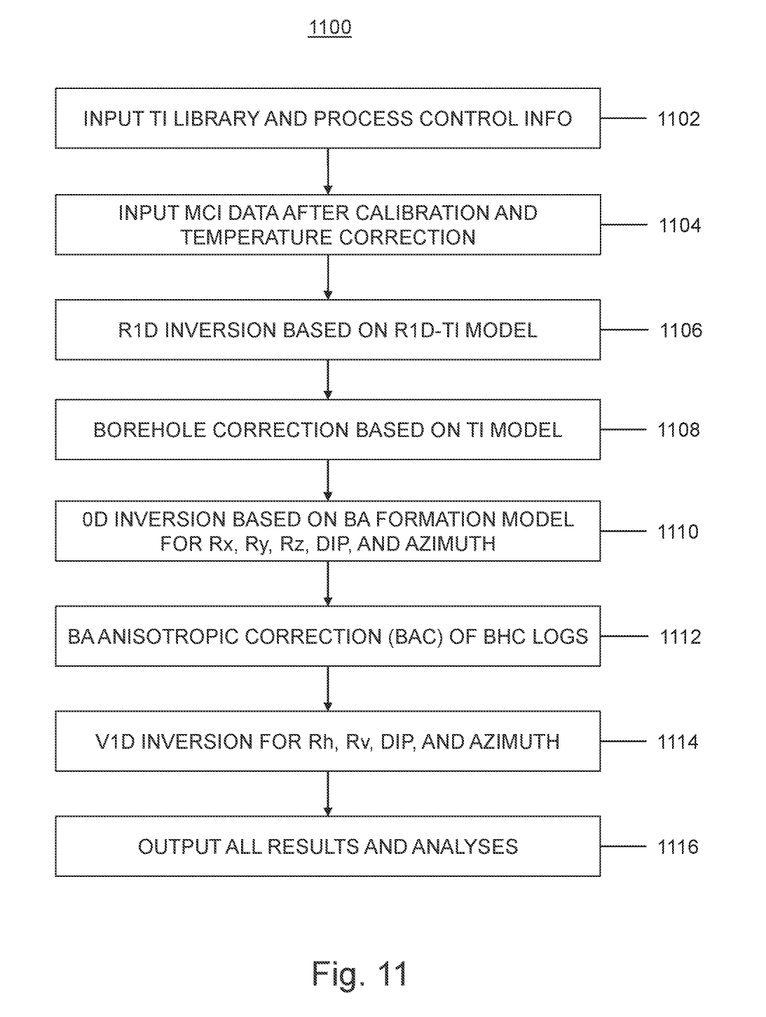

FIG. 11 shows an example flow chart of a processing method 1100 comprising multi-model inversion processing and interpretation based on multiple forward models with BA and TI anisotropies, using MCI measurements. The method 1100 provides for real-time determination of formation horizontal and vertical resistivities (Rx, Ry, and Rz), dip, strike/azimuth, and fracture evaluation (identification and quantification).

At operation 1102, a TI library is inputted with 3D numerical codes such as finite difference (FD), finite element (FE) or integral equation (IE) methods. The TI library is also inputted with processing control information such as mud and caliper indicators, which indicates whether the parameters are available or not. The TI library can be created based on the R1D-TI model, as previously discussed with respect to FIG. 4.

At operation 1104, MCI measurement data captured by a triaxial MCI tool in a borehole extending through a subsurface geological formation is inputted after calibration, temperature correction, and other preprocessing. The MCI measurement data includes data representing downhole formations and can be obtained using the logging tools previously described in FIGS. 1-3. Operation 1104 can also include preprocessing such as normalization, direction, and caliper measurements if such data is available from the TI library. The MCI measurement data may be multi-frequency data, and may be taken at multiple spacings. In some embodiments, the MCI measurement data can be single-frequency measurements for the respective arrays of the tool. In this embodiment, none of the pre-processing operations are multi-frequency operations, so that any and all of the preprocessing operations can be performed with respect to log data captured at a single frequency.

Inversion processing begins at operation 1106 with R1D inversion comprising an iterative operation using the TI library for calculating best fit values for formation Rh, Rv, dip, strike/azimuth, and tool position in a hole. The values thus calculated for the inverted TI parameters for the formation. Operation 1108 comprises performing borehole-effect correction (BHC) to all tensor components for different subarrays operated at different frequencies using at least some of the inverted TI parameters calculated in operation 1106. Thus, operation 1108 provides MCI borehole corrected measurement data by removing the effect of the presence of the borehole from MCI measurement data, thereby resulting in BHC logs.

At operation 1110, 0D inversion is performed based on the 0D-BA formation model, as previously discussed with respect to FIG. 5, thereby recovering BA formation parameters Rx, Ry, Rz, dip, and azimuth/strike.

Operation 1112 comprises performing BA anisotropic effect correction (BAC) to BHC logs using the BHC logs from operation 1108 and estimated Rx, Ry, Rz, dip and azimuth strike from operation 1110. Operation 1112 can be performed using either equations (3) or (4) provided below:

C_{bac}=C_{BHC}+(C_{OD}^{ti}−C_{OD}^{ba}) (3)

C_{bac}=C_{BHC}+α×(C_{OD}^{ti}−C_{OD}^{ba}) (4)

In equation (3) and equation (4) above, C_{bac} represents the BAC tensor component (e.g., XX, YY, . . . , ZZ) for a fixed subarray operated at a given frequency. C_{BHC} represents the corresponding BHC component tensor. C_{OD}^{ti} represents the calculated tensor component in a 0D-TI formation with parameters of R_{Ji}=\sqrt{RₓR_{y}}, R_{z}, dip, and azimuth/strike, which are obtained in real-time computation. C_{OD}^{ba} represents the calculated tensor component in a 0D-BA formation with parameters of Rx, Ry, Rz, dip and azimuth/strike, which can be pre-calculated by a semi-analytical solution and saved as a look-up table or a data library for real-time processing. α represents a parameter for adjusting the BAC tensor component C_{bac}.

It is noted that if the MCI measurement data is affected by shoulder-bed effects (e.g., such as in thin beds), the R1D or 0D inversions, from operations 1106 and 1110, respectively, can be erroneous. At operation 1114, V1D inversion processing is performed to produce inverted BA parameters, from which MCI shoulder corrected measurements are calculated. If the V1D forward modeling in the BA formation is not available (or if initial guesses can be determined by a 0D inversion based on the TI formation model), V1D inversion processing is performed with the BAC tensor components for recovering Rh, Rv, dip, and azimuth strike. Alternatively, if the V1D forward modeling in the BA formation is available and of affordable speed, V1D inversion processing is performed using the BHC tensor components for recovering Rx, Ry, Rz, dip, and azimuth/strike. It is noted that it is common for V1D forward modeling in BA formations to be much slower than V1D forward modeling in TI formations.

At operation 1116, the processed results are outputted for analyses and other applications. In some embodiments operation 1116 includes comparing among different inverted logs from multiple inversion processing methods. Further, fracture interpretation (e.g., detection/identification and quantification) can be delivered from the BAC based on the raw data and processed logs based on different forward models (e.g., TI and BA models). In some embodiments, operation 1116 can include operating a controlled device based at least in part on the inverted parameters generated from method 1100.

The controlled device comprises a display device to display one or more formation characteristics based at least in part on the inverted BA parameters. Instead, or in addition, the controlled device may comprise a control mechanism for controlling mechanism for borehole measurement, drilling, and/or development based at least in part on formation characteristics calculated based on the inverted BA parameters.

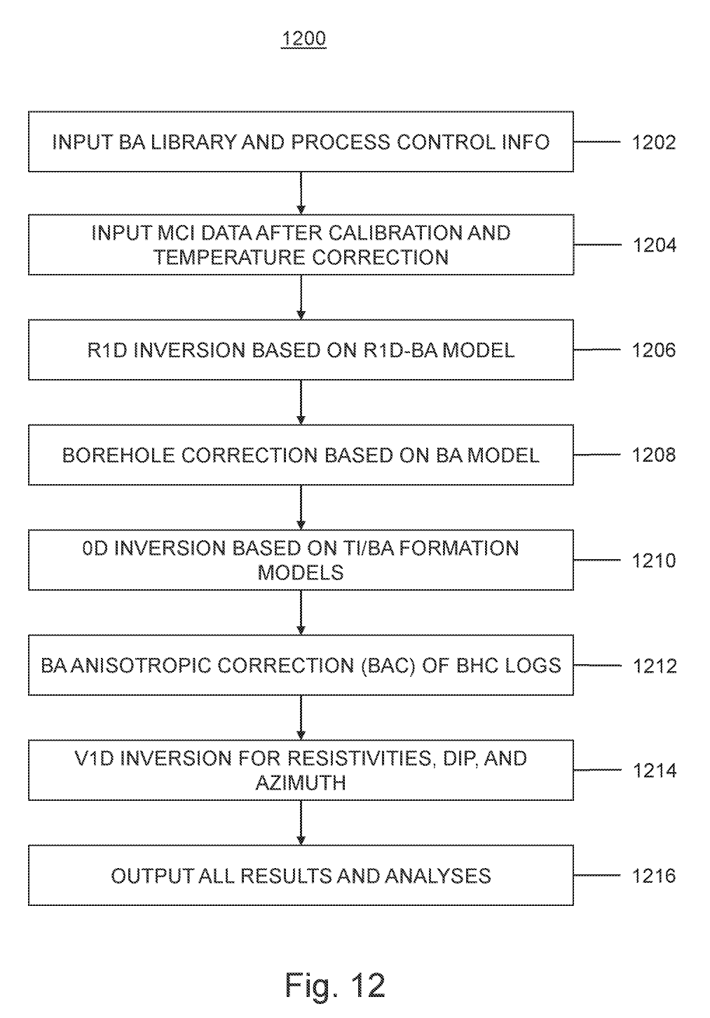

FIG. 12 shows an example flow chart of a processing method 1200 comprising multi-model inversion processing and interpretation based on multiple forward models with BA and TI anisotropies, using MCI measurements. The method 1200 provides for real-time determination of formation horizontal and vertical resistivities (Rx, Ry, and Rz), dip, strike/azimuth, and fracture evaluation (identification and quantification).

At operation 1202, a BA library is inputted with 3D numerical codes such as finite difference (FD), finite element (FE) or integral equation (IE) methods. The BA library is also inputted with processing control information such as mud and caliper indicators, which indicates whether the parameters are available or not. The BA library can be created based on the R1D-BA model, as previously discussed with respect to FIG. 5.

At operation 1204, MCI measurement data captured by a triaxial MCI tool in a borehole extending through a subsurface geological formation is inputted after calibration, temperature correction, and other preprocessing. Operation 1204 can also include preprocessing such as normalization, direction, and caliper measurements if such data is available from the BA library. The MCI measurement data may be multi-frequency data, and may be taken at multiple spacings. In some embodiments, the MCI measurement data can be single-frequency measurements for the respective arrays of the tool. In this embodiment, none of the pre-processing operations are multi-frequency operations, so that any and all of the preprocessing operations can be performed with respect to log data captured at a single frequency.

Inversion processing begins at operation 1206 with R1D inversion comprising an iterative operation using the BA library for calculating best fit values for formation Rx, Ry, Rz, dip, strike azimuth, and tool position in a hole. The values thus calculated for the inverted BA parameters for the formation. Operation 1208 comprises performing borehole-effect correction (BHC) to all tensor components for different subarrays operated at different frequencies using at least some of the inverted BA parameters calculated in operation 1206. Thus, operation 1208 provides MCI borehole corrected measurement data by removing the effect of the presence of the borehole from MCI measurement data, thereby resulting in BHC logs.

At operation 1210, 0D inversion is performed for estimating formation tri-axial resistivities (Rx, Ry, and Rz) and bi-axial resistivities (Rh and Rv), dip, and azimuth/strike. It is noted that the 0D inversion processing of operation 1210 includes both 0D inversion based on the 0D-TI formation model, as previously discussed with respect to FIG. 4, and 0D inversion based on the 0D-BA formation model, as previously discussed with respect to FIG. 5.

Operation 1212 comprises performing BA anisotropic correction (BAC) to BHC logs using the BHC logs from operation 1208 and estimated Rx, Ry, Rz, dip and azimuth/strike from operation 1210. Operation 1212 can be performed using either equations (3) or (4) as previously discussed.

It is noted that if the MCI measurement data is affected by shoulder-bed effects (e.g., such as in thin beds), the R1D or 0D inversions, from operations 1206 and 1210, respectively, can be erroneous. At operation 1214, V1D inversion processing is performed to produce inverted BA parameters, from which MCI shoulder corrected measurements are calculated. If the V1D forward modeling in the BA formation is not available, and if initial guesses for a V1D inversion can be determined by a 0D inversion based on the TI formation model, V1D inversion processing is performed with the BAC tensor components for recovering Rh, Rv, dip, and azimuth strike. Alternatively, if the V1D forward modeling in the BA formation is available and of affordable speed, V1D inversion processing is performed using the BHC tensor components for recovering Rx, Ry, Rz, dip, and azimuth/strike. It is noted that it is common for V1D forward modeling in BA formations to be much slower than V1D forward modeling in TI formations. Initial guesses for V1D inversion processing can be obtained by a V1D inversion based on a TI-formation model or by a 0D inversion based on a BA model in operation 1210.

At operation 1216, the processed results are outputted for analyses and other applications. In some embodiments operation 1216 includes comparing among different inverted logs from multiple inversion processing methods. Further, fracture interpretation (e.g., detection/identification and quantification) can be delivered from the BAC based on the raw data and processed logs based on different forward models (e.g., TI and BA models). In some embodiments, operation 1216 can include operating a controlled device based at least in part on the inverted parameters generated from method 1200.

Hence this application demonstrates that multi-model inversion processing can be used with a combination of R1D, 0D, V1D inversions and BA anisotropic correction to BHC logs for enhanced processing accuracy of determining formation BA anisotropy (or triaxial resistivities: Rx, Ry, and Rz), dip, and azimuth strike in BA formation conditions.

### Example System

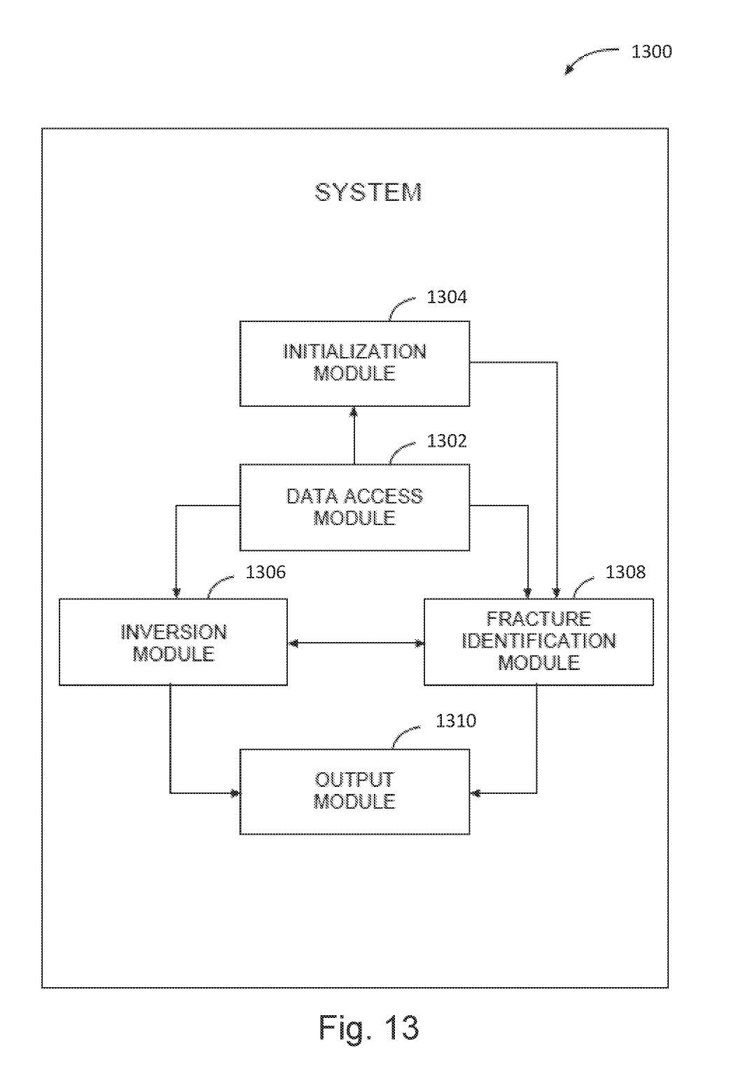

FIG. 13 is a schematic block diagram of an example system 1300 for estimating subsurface formation and fracture properties, according to an example embodiment. The example system 1300 of FIG. 13 may be configured to perform one or more of the methods described above with reference to FIGS. 11 and 12. The system 1300 may comprise multiple hardware-implemented modules for performing the respective operations described previously.

In this example embodiment, the system 1300 includes a data access module 1902 configured to access MCI measurement data from initialization module 1304. An inversion module 1306 is configured to perform inversion in accordance with one or more of the example embodiments discussed with reference to FIGS. 11 and 12, while a fracture identification module 1308 is configured to identify and characterize one or more fractures based on results of the inversion, according to the fracture identifications schemes and/or formulas discussed above. The system 1300 further comprises an output module 1310 configured to deliver the estimated measurement zone parameters. The output module 1310 may in some embodiments deliver numerical tables with estimated values for formation resistivity at multiple different points along the borehole 110. In other embodiments, a graphical plot that maps the estimated values to the borehole positions may be printed in hard copy, and/or may be displayed on a display screen.

### Modules, Components, and Logic

Certain embodiments are described herein as including logic or a number of components, modules, or mechanisms. Modules may constitute either software modules, with code embodied on a non-transitory machine-readable medium (i.e., such as any conventional storage device, such as volatile or non-volatile memory, disk drives or solid state storage devices (SSDs), etc.), or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry or in temporarily configured circuitry (e.g., configured by software), may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers examples of machines including processors), with these operations being accessible via a network (e.g., the Internet) and via one or more appropriate interfaces (e.g., Application Program Interfaces (APIs).)

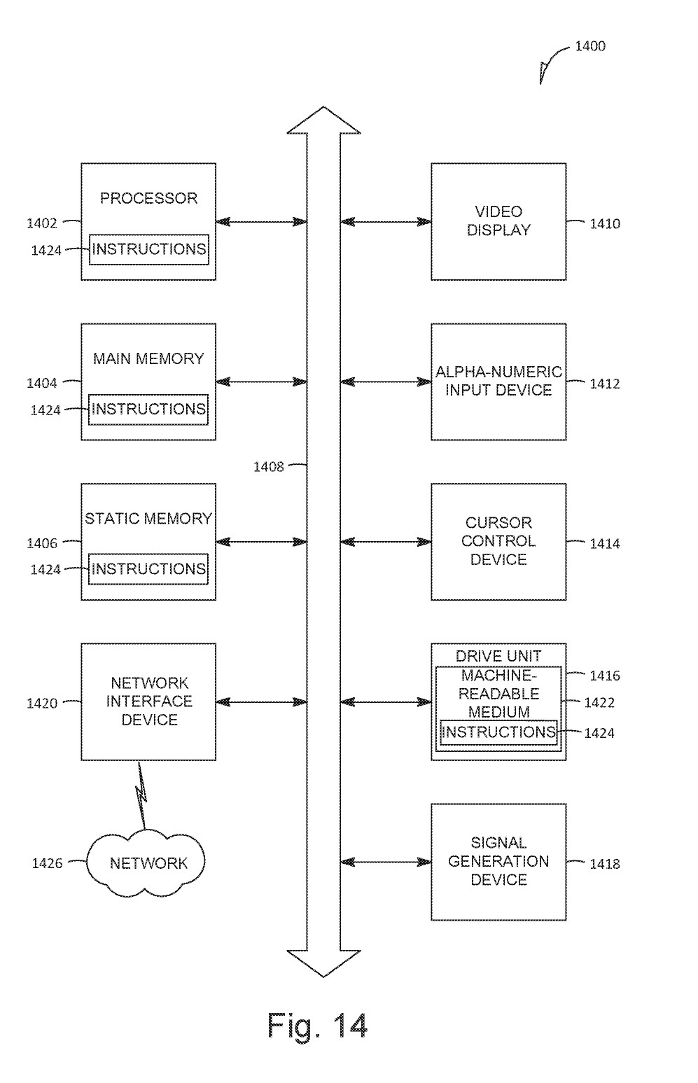

FIG. 14 shows a diagrammatic representation of a machine in the example form of a computer system 1400 within which a set of instructions 1424 may be executed for causing the machine to perform any one or more of the methodologies discussed herein. For example, the surface computer 132 (FIG. 1) or any one or more of its components may be provided by the system 1400.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU) a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alpha-numeric input device 1412 (e.g., a keyboard), a cursor control device 1414 (e.g., a mouse), a disk drive unit 1416, a signal generation device 1418 (e.g., a microphone/speaker) and a network interface device 1420.

The disk drive unit 1416 includes a machine-readable or computer-readable storage medium 1422 on which is stored one or more sets of instructions 1424 (e.g., software) embodying any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting non-transitory machine-readable media. The instructions 1424 may further be transmitted or received over a network 1426 via the network interface device 1420.

While the machine-readable storage medium 1422 is shown in an example embodiment to be a single medium, the term “machine-readable medium” should be taken to include a single medium or multiple media (e.g., a centralized or distributed database and/or associated caches and servers) that store the one or more sets of instructions 1424. The term “machine-readable medium” shall also be taken to include any medium that is capable of storing a set of instructions for execution by the machine and that cause the machine to perform any one or more of the methodologies of this disclosure. The term “machine-readable medium” shall accordingly be taken to include, but not be limited to, solid-state memory devices of all types, as well as optical and magnetic media.

Although this disclosure has been described with reference to specific example embodiments, it will be evident that various modifications and changes may be made to these embodiments without departing from the broader scope of the disclosure. Accordingly, the specification and drawings are to be regarded in an illustrative rather than a restrictive sense. To better illustrate the apparatus and systems disclosed herein, a non-limiting list of examples is provided:

1. A method includes accessing multicomponent induction (MCI) measurement data indicative of resistivity measurements captured by a measurement tool in a borehole extending through a subsurface formation; in an automated procedure using one or more computer processors: calculating inverted transverse isotropic (TI) parameters by performing a TI inversion operation based on the MCI measurement data using a TI formation model; generating borehole-effect corrected (BHC) logs by performing borehole correction based on the TI formation model using the inverted TI parameters; calculating inverted biaxial anisotropy (BA) parameters by performing an iterative BA inversion operation based on the MCI measurement data using a BA formation model; performing BA anisotropic effect correction to the BHC logs based on the inverted BA parameters; and operating a controlled device based at least in part on the inverted BA parameters

2. The method of example 1, further including performing a second BA inversion operation based at least in part on the MCI measurement data using a second BA formation model.

3. The method of either of examples 1 or 2, in which the second BA formation model is a vertically one-dimensional model (V1D-BA) accounting for biaxial anisotropy to resistivity, the method further including calculating shoulder-effect-corrected formation parameters based on performance of the second BA inversion operation.

4. The method of any of examples 1-3, in which the controlled device includes a display device to display one or more formation characteristics based at least in part on the inverted BA parameters.

5. The method of any of examples 1-4, in which the TI formation model is a radially one-dimensional model (RID-TI) that accounts for transverse isotropy to resistivity.

6. The method of any of examples 1-5, further including calculating, based at least in part on the inverted TI parameters, MCI borehole corrected measurement data by processing the MCI measurement data to correct for borehole effects.

7. The method of any of examples 1-6, in which the BA formation model is a zero dimensional model (0D-BA) that accounts for biaxial formation anisotropy, the 0D-BA assuming a homogeneous unbounded formation which is biaxially anisotropic in resistivity.

8. The method of any of examples 1-7, in which the MCI measurement data is preprocessed by calibration and temperature correction operations.

9. The method of any of examples 1-8, further including performing automated fracture analysis to identify one or more formation fracture properties of the subsurface formation based at least in part on one or more of the inverted BA parameters

10. A method includes accessing multicomponent induction (MCI) measurement data indicative of resistivity measurements captured by a measurement tool in a borehole extending through a subsurface formation; in an automated procedure using one or more computer processors: calculating inverted biaxial anisotropy (BA) parameters by performing an iterative BA inversion operation based on the MCI measurement data using a BA formation model; generating borehole-effect corrected (BHC) logs by performing borehole correction based on the BA formation model using the inverted BA parameters; calculating formation tri-axial and bi-axial resistivities by performing a multi-model inversion operation; performing BA anisotropic effect correction to the BHC logs based at least in part on the tri-axial resistivities and bi-axial resistivities; and operating a controlled device based at least in part on the tri-axial resistivities and bi-axial resistivities.

11. The method of example 10, further including performing a second BA inversion operation based at least in part on the MCI measurement data using a second BA formation model.

12. The method of either of examples 10 or 11, in which the second BA formation model is a vertically one-dimensional model (V1D-BA) accounting for biaxial anisotropy to resistivity, the method further including calculating shoulder-effect-corrected formation parameters based on performance of the second BA inversion operation.

13. The method of any of examples 10-12, in which the controlled device includes a display device to display one or more formation characteristics based at least in part on the inverted BA parameters.

14. The method of any of examples 10-13, in which the multi-model inversion operation includes a first zero dimensional model that accounts for biaxial formation anisotropy (0D-BA) and a second zero dimensional model that accounts for transverse isotropy to resistivity (0D-TI).

15. The method of any of examples 10-14, further including calculating, based at least in part on the tri-axial resistivities and bi-axial resistivities, MCI borehole corrected measurement data by processing the MCI measurement data to correct for borehole effects.

16. The method of any of claims 10-15, in which the MCI measurement data is preprocessed by calibration and temperature correction operations.

17. The method of any of claims 10-16, further including performing automated fracture analysis to identify one or more formation fracture properties of the subsurface formation based at least in part on one or more of the inverted BA parameters.

18. A system includes a data access module to access multicomponent induction (MCI) measurement data indicative of resistivity measurements captured by a measurement tool in a borehole extending through a subsurface formation; and an inversion module that includes one or more computer processors to calculate inverted transverse isotropic (TI) parameters by performing a TI inversion operation based on the MCI measurement data using a TI formation model; generate borehole-effect corrected (BHC) logs by performing borehole correction based on the TI formation model using the inverted TI parameters; calculate inverted biaxial anisotropy (BA) parameters by performing an iterative BA inversion operation based on the MCI measurement data using a BA formation model; and perform BA anisotropic effect correction to the BHC logs based on the inverted BA parameters.

19. The system of example 18, further including a fracture identification module to perform an automated fracture detection operation for determining presence of a fracture in the formation, the automated fracture detection operation being based at least in part on the inverted BA parameters.

20. The system of any of the preceding examples, in which the inversion module is further configured to perform a second BA inversion operation based on a vertically one-dimensional model (V1D-BA) accounting for biaxial anisotropy to resistivity for shoulder-effect correction.

21. The system of any of the preceding examples, in which the measurement tool includes a sonde lowered into the borehole using a wireline cable.

22. The system of any of the preceding examples, in which the measurement tool includes a logging while drilling tool included as part of a bottom hole assembly configured to capture measurements during drilling operations.

23. The system of any of the preceding examples, further including a logging system for capturing subsurface measurement data.

24. The system of any of the preceding examples, in which the logging system includes a multi-array triaxial induction tool to measure subsurface formation resistivity.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

Although an embodiment has been described with reference to specific example embodiments, it will be evident that various modifications arid changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method, comprising:
accessing multicomponent induction (MCI) measurement data indicative of resistivity measurements captured by a measurement tool in a borehole extending through a subsurface formation;
in an automated procedure using one or more computer processors:
calculating inverted transverse isotropic (TI) parameters by performing a TI inversion operation based on the MCI measurement data using a TI formation model;
generating borehole-effect corrected (BHC) logs by performing borehole correction based on the TI formation model using the inverted TI parameters;
calculating inverted biaxial anisotropy (BA) parameters by performing an iterative BA inversion operation based on the MCI measurement data using a BA formation model;
performing BA anisotropic effect correction to the BHC logs based on the inverted BA parameters; and
operating a controlled device based at least in part on the inverted BA parameters.

2. The method of claim 1, further comprising:
performing a second BA inversion operation based at least in part on the MCI measurement data using a second BA formation model, wherein the second BA formation model is a vertically one-dimensional model (V1D-BA) accounting for biaxial anisotropy to resistivity; and
calculating shoulder-effect-corrected formation parameters based on performance of the second BA inversion operation.

3. (canceled)

4. The method of claim 1, wherein the controlled device comprises a display device to display one or more formation characteristics based at least in part on the inverted BA parameters.

5. The method of claim 1, wherein the TI formation model is a radially one-dimensional model (RID-TI) that accounts for transverse isotropy to resistivity.

6. The method of claim 5, further comprising: calculating, based at least in part on the inverted TI parameters, MCI borehole corrected measurement data by processing the MCI measurement data to correct for borehole effects.

7. The method of claim 1, wherein the BA formation model is a zero dimensional model (0D-BA) that accounts for biaxial formation anisotropy, the 0D-BA assuming a homogeneous unbounded formation which is biaxially anisotropic in resistivity.

8. The method of claim 1, wherein the MCI measurement data is preprocessed by calibration and temperature correction operations.

9. The method of claim 1, further comprising: performing automated fracture analysis to identify one or more formation fracture properties of the subsurface formation based at least in part on one or more of the inverted BA parameters.

10. A method, comprising:
accessing multicomponent induction (MCI) measurement data indicative of resistivity measurements captured by a measurement tool in a borehole extending through a subsurface formation;
in an automated procedure using one or more computer processors:
calculating inverted biaxial anisotropy (BA) parameters by performing an iterative BA inversion operation based on the MCI measurement data using a BA formation model;
generating borehole-effect corrected (BHC) logs by performing borehole correction based on the BA formation model using the inverted BA parameters;
calculating formation tri-axial and bi-axial resistivities by performing a multi-model inversion operation;
performing BA anisotropic effect correction to the BHC logs based at least in part on the tri-axial resistivities and bi-axial resistivities; and
operating a controlled device based at least in part on the tri-axial resistivities and bi-axial resistivities.

11. The method of claim 10, further comprising:
performing a second BA inversion operation based at least in part on the MCI measurement data using a second BA formation model, wherein the second BA formation model is a vertically one-dimensional model (V1D-BA) accounting for biaxial anisotropy to resistivity; and
calculating shoulder-effect-corrected formation parameters based on performance of the second BA inversion operation.

12. (canceled)

13. The method of claim 10, wherein the controlled device comprises a display device to display one or more formation characteristics based at least in part on the inverted BA parameters.

14. The method of claim 10,
wherein the multi-model inversion operation includes a first zero dimensional model that accounts for biaxial formation anisotropy (0D-BA) and a second zero dimensional model that accounts for transverse isotropy to resistivity (0D-TI),
wherein the method comprises calculating, based at least in part on the tri-axial resistivities and bi-axial resistivities, MCI borehole corrected measurement data by processing the MCI measurement data to correct for borehole effects.

15. (canceled)

16. The method of claim 10, wherein the MCI measurement data is preprocessed by calibration and temperature correction operations.

17. The method of claim 10, further comprising: performing automated fracture analysis to identify one or more formation fracture properties of the subsurface formation based at least in part on one or more of the inverted BA parameters.

18. A system comprising:
a data access module to access multicomponent induction (MCI) measurement data indicative of resistivity measurements captured by a measurement tool in a borehole extending through a subsurface formation; and
an inversion module that comprises one or more computer processors to calculate inverted transverse isotropic (TI) parameters by performing a TI inversion operation based on the MCI measurement data using a TI formation model; generate borehole-effect corrected (BHC) logs by performing borehole correction based on the TI formation model using the inverted TI parameters; calculate inverted biaxial anisotropy (BA) parameters by performing an iterative BA inversion operation based on the MCI measurement data using a BA formation model; and perform BA anisotropic effect correction to the BHC logs based on the inverted BA parameters.

19. The system of claim 18, further comprising a fracture identification module to perform an automated fracture detection operation for determining presence of a fracture in the formation, the automated fracture detection operation being based at least in part on the inverted BA parameters.

20. The system of claim 18, wherein the inversion module is further configured to perform a second BA inversion operation based on a vertically one-dimensional model (V1D-BA) accounting for biaxial anisotropy to resistivity for shoulder-effect correction.

21. The system of claim 18, wherein the measurement tool includes a sonde lowered into the borehole using a wireline cable.

22. The system of claim 18, wherein the measurement tool includes a logging while drilling tool included as part of a bottom hole assembly configured to capture measurements during drilling operations.

23. The system of claim 18, further comprising a logging system for capturing subsurface measurement data, wherein the logging system includes a multi-array triaxial induction tool to measure subsurface formation resistivity.

24. (canceled)
